(19) United States
(12) Patent Application Publication
(10) Pub. No.: US 2022/0405139 A1
(43) Pub. Date: Dec. 22, 2022

(54) ANTENNA ARRAY DEVICE

(71) Applicant: SKYREC Inc., Taipei City (TW)

(72) Inventors: Kai-Shian MOOI, Taipei City (TW); Chun-Wei LIAO, Taipei City (TW)

(21) Appl. No.: 17/807,386

(22) Filed: Jun. 17, 2022

Related U.S. Application Data
(60) Provisional application No. 63/211,565, filed on Jun. 17, 2021.

(51) Int. Cl. G06F 9/50; G06T 1/20

(52) U.S. Cl. CPC G06F 9/505; G06F 9/5077; G06T 1/20

(57) ABSTRACT

A virtual hardware management device is provided, which includes a memory and a processing unit. The processing unit is configured for executing the multiple instructions to perform the following operations: when detecting that the load rate is more than the high level threshold, comparing respective priorities of multiple processing flows; selecting at least one of the multiple processing flows to perform at least one of analysis frequency reduction processing, detection reduction processing, or flow pause processing according to a comparing result until the load rate is not more than the high level threshold; and generating respective resource allocation ratio of multiple operators in the multiple processing flows according to respective resource weights of the multiple operators, and using a virtual hardware unit to execute the multiple operators according to the multiple resource allocation ratios.

### CROSS-REFERENCE TO RELATED APPLICATION

This application claims priority to U.S. Provisional Application Ser. No. 63/211,565, filed Jun. 17, 2021, which is herein incorporated by reference in its entirety.

### BACKGROUND

### Field of Disclosure

The present disclosure relates to a virtual hardware management device and method.

### Description of Related Art

For the current image processing, complicated processing procedures are often required. In particular, algorithms for machine learning (e.g. deep learning or computer vision) need to use a lot of computing resources. However, it is very difficult to manage to use various algorithms and use the corresponding resources. Therefore, how to efficiently use the various algorithms and use the corresponding resources is a problem that those skilled in the art want to solve.

### SUMMARY

The disclosure provides a virtual hardware management device, which comprises a memory and a processing unit. The memory is configured for storing a plurality of instructions and a plurality of processing flows. The processing unit is connected to the memory, and configured for executing the plurality of instructions to perform the following operations: detecting whether a load rate of a virtual hardware unit is more than a high level threshold, wherein the virtual hardware unit is created by virtualizing a physical hardware component; when detecting that the load rate is more than the high level threshold, comparing respective priorities of the plurality of processing flows; selecting at least one of the plurality of processing flows to perform at least one of analysis frequency reduction processing, detection reduction processing, or flow pause processing according to a comparing result until the load rate is not more than the high level threshold; and generating respective resource allocation ratio of a plurality of operators in the plurality of processing flows according to respective resource weights of the plurality of operators, and using the virtual hardware unit to execute the plurality of operators according to the plurality of resource allocation ratios.

The disclosure provides a virtual hardware management method, comprising: (a) sorting a plurality of processing flows according to respective priorities of the plurality of processing flows to generate a sorted sequence, wherein the sorting sequence comprises the plurality of processing flows which are sorted, wherein the processing flows comprises a plurality of operators; (b) detecting whether a load rate of a virtual hardware unit is more than a high level threshold, wherein the virtual hardware unit is created by virtualizing a physical hardware component; (c) when detecting that the load rate is more than the high level threshold, selecting the processing flow with the smallest priority in the sorting sequence as a target flow; (d) performing analysis frequency reduction processing on the target flow, and deleting the target flow in the sorting sequence, thereby detecting again whether the load rate is not more than the high level threshold; (e) when detecting that the load rate is still more than the high level threshold, perform steps (c) to (d) again; and (f) when detecting that the load rate is not more than the high level threshold, generating respective resource allocation ratio of the plurality of operators according to respective resource weights of the plurality of operators in the plurality of processing flows, and using the virtual hardware unit to execute the plurality of operators according to the plurality of resource allocation ratios.

The disclosure provides A virtual hardware management method, comprising: detecting whether a load rate of a virtual hardware unit is more than a high level threshold, wherein the virtual hardware unit is created by virtualizing a physical hardware component; when detecting that the load rate is more than the high level threshold, randomly selecting one of a first processing flow and a second processing flow as a target flow, wherein a priority of the first processing flow is equal to a priority of the second processing flow, the first processing flow and the second processing flow each comprises a plurality of operators; performing analysis frequency reduction processing on the target flow, thereby detecting again whether the load rate is not more than the high level threshold; when detecting that the load rate is more than the high level threshold, selecting another one of a first processing flow and a second processing flow as the target flow, and performing the analysis frequency reduction processing on the target flow, thereby detecting again whether the load rate is not more than the high level threshold; and when detecting that the load rate is not more than the high level threshold, generating respective resource allocation ratio of the plurality of operators according to respective resource weights of the plurality of operators in the first processing flow and the second processing flow, and using the virtual hardware unit to execute the plurality of operators according to the plurality of resource allocation ratios.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a virtual hardware management device of the present disclosure.

FIG. 2 is a schematic diagram of multiple processing flows in some embodiments according to the present disclosure.

FIG. 3 is a virtual hardware management method of the present disclosure.

FIG. 4 is a schematic diagram of processing performed by a virtual hardware unit on different states in some embodiments according to the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

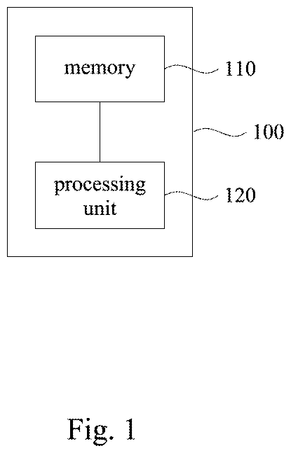

Reference is made to FIG. 1, which is a block diagram of a virtual hardware management device 100 of the present disclosure. The virtual hardware management device 100 includes a memory 110 and a processing unit 120. The processing unit 120 is connected to the memory 110.

In some embodiments, the virtual hardware management device 100 is established by a computer, a server or a processing center. In some embodiments, the memory 110 can be implemented using a memory cell, a flash memory, a ROM, a hard disk, or any equivalent storage device. In some embodiments, the processing unit 120 can be implemented by an integrated circuit unit, a central processing unit (CPU), or a computing unit (e.g. neural-network processing unit (NPU) or graphics processing unit (GPU)).

In some embodiments, the virtual hardware management device 100 is not limited to include the memory 110 and the processing unit 120. The virtual hardware management device 100 can further include at least one other memory, at least one other processing unit or other components required to operating the virtual hardware management device 100 in various applications. In this time, the processing unit 120 can be regarded as a main processing unit. For example, the virtual hardware management device 100 can further include another processing unit, an output interface (e.g., a display panel for displaying information), an input interface (e.g., a touch panel, a keyboard, a microphone, a scanner or a flash memory reader) and a communication circuit (e.g., a WiFi communication module, a Bluetooth communication module, a wireless telecommunication module, etc.).

In some embodiments, the processing unit 120 can virtualize all physical hardware components (e.g. the processing unit 120, the memory 110 and the NPU) in the virtual hardware management device 100 to generate virtual hardware units (e.g. virtual CPU, virtual memory, and virtual NPU).

In some embodiments, the processing unit 120 can virtualize the physical hardware component of the same brand to the same virtual hardware unit (because the physical hardware components of the same brand have similar computing functions). For example, the processing unit 120 can virtualize CPUs of the same brand (e.g. Intel or AMD) to the same virtual CPU, and virtualize NPUs of the same brand (e.g. NVIDIA or AMD) to the same virtual NPU.

In this embodiment, the memory 110 stores multiple processing flows. In some embodiments, the processing flow can be computer vision and deep learning (CVDL) analysis flow. In some embodiments, the multiple processing flows can comprise multiple operators. In detail, the processing flow can consists of multiple operators (i.e. CVDL operator). In some embodiments, the operator can be a source operator, a deep learning operator, a computer vision operator, a metadata operator, a statistic operator, a storage operator, a network operator, a sensor operator, a pan-tilt-zoom (PTZ) operator, a render operator, a monitoring operator, and etc.

In detail, the source operator can perform receiving various video sources (e.g. video file, RTSP, HTTP and etc.). The deep learning operator can perform analysis functions for deep learning algorithms (e.g. detection, classification, clustering and etc.). The computer vision operator can perform analysis functions for of computer vision algorithms. The metadata operator can perform labeling for various analysis results (e.g. object size, location, movement speed, age, gender and etc.). The statistic operator can perform statistics for the various analysis results and data (e.g. median age, gender ratio, clothing color ratio and etc.). The storage operator can perform storing the various analysis results and data in persistent storage (e.g. hard-disk and etc.). The network operator can perform transmitting the various analysis results and the data through networks. The sensor operator can perform receiving and controlling alarms from external sensors. The PTZ operator can perform controlling PTZ cameras. The render operator can perform drawing the various analysis results and the original video. The monitoring operator can perform real-time monitoring of the operation status of various algorithms.

In some embodiments, the processing flow in memory 110 has a priority, where the priority indicates a degree to which the processing flow is preferentially processed by the processing unit 120. In other words, the one priority corresponds to the one processing flow. In some embodiments, the operator has a resource weight, where the resource weight indicates a degree to which the operator preferentially obtains resources of the virtual hardware unit. In other words, the one resource weight corresponds to the one operator. In addition, the operator has different resource weight for different virtual hardware unit, and each of the operators have different performing time.

For example, the source operator tends to require high NPU resource, and the resource weight of the source operator for the virtual NPU has a high value (for the virtual CPU has a low value). The deep learning operator also tends to require high NPU resource, and the resource weight of the source operator for the virtual NPU has a high value (for the virtual CPU has a low value). The computer vision operator also tends to require high NPU resource, and the resource weight of the source operator for the virtual NPU has a high value (for the virtual CPU has a low value). The metadata operator tends to require high CPU resource, and the resource weight of the source operator for the virtual NPU has a low value (for the virtual CPU has a high value). The statistic operator tends to require high CPU resource, and the resource weight of the source operator for the virtual NPU has a low value (for the virtual CPU has a high value). It should be noted that subsequent paragraphs will explain the functions of the priority and the resource weight in detail.

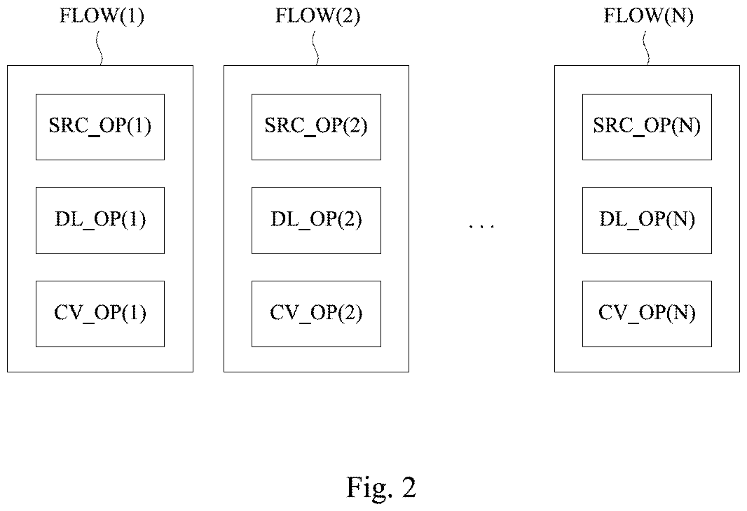

The following is a practical example to illustrate the composition of the processing flow. Reference is made to FIG. 2, which is a schematic diagram of the multiple processing flows FLOW(1)-FLOW(N) in some embodiments according to the present disclosure. As shown in FIG. 2, the multiple processing flows FLOW(1)-FLOW(N) exist, where N is any positive integer more than 0, the processing flow FLOW(1) can consists of the source operator SRC_OP, the deep learning operator DL_OP(1) and the computing vision operator CV_OP(1), and the processing flow FLOW(2) can consists of the source operator SRC_OP, the deep learning operator DL_OP(2) and the computing vision operator CV_OP(2). By analogy, the processing flow FLOW(3)-FLOW(N) are also composed of the same type of the operator. In this way, the processing unit 120 can perform these operators in these processing flows in sequential or in parallel.

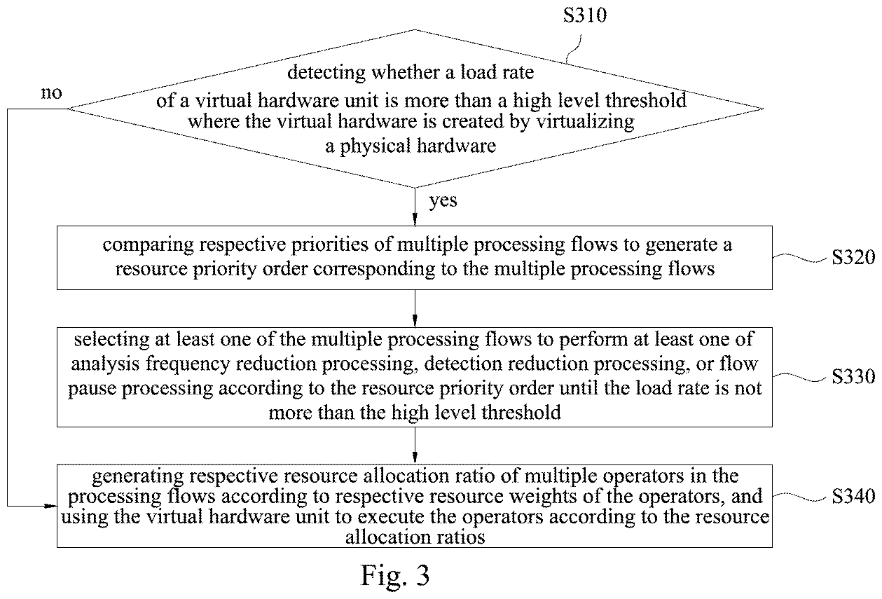

Reference is made to FIG. 3, which is a flowchart of a virtual hardware management method of the present disclosure. The virtual hardware management device 100 shown in FIG. 1 can be used to execute the virtual hardware management method shown in FIG. 3.

As shown in FIG. 3, the virtual hardware management method comprises steps S310-S340, and steps S310-S340 are all performed by the processing unit 120.

Firstly, in step S310, detecting whether a load rate of a virtual hardware unit is more than a high level threshold (e.g. 90%), where the virtual hardware unit is created by virtualizing the physical hardware component. If yes, entering step S320. If no, entering step S340. In other words, if yes, the virtual hardware unit is in a state of overloud. If no, the virtual hardware unit is not in the state of overloud.

In some embodiment, the above-mentioned detecting can be periodic. In some embodiment, the load rate indicates a degree (e.g. 80%) of usage of the virtual hardware unit. In some embodiment, the high level threshold is preset by a user or obtained from past experiments.

Furthermore, in step S320, comparing respective priorities of the multiple processing flows. In step S330, selecting at least one of the multiple processing flows to perform at least one of analysis frequency reduction processing, detection reduction processing, or flow pause processing according to a comparing result until the load rate is not more than the high level threshold. In some embodiment, the comparing result indicates an order of selecting of the multiple processing flows, where the processing flow with the larger priority has the higher selecting priority in the comparing result.

In some embodiment, the multiple processing flows can be sorted according to the comparing result to generate a sorted sequence, where the sorted sequence comprises the multiple processing flows which are sorted. In some embodiment, the processing flow with the larger priority is sorted more foremost in the sorted sequence. Next, the processing flow with the smallest priority is selected in the sorting sequence as a target flow, an image analysis frequency corresponding to the target flow is reduced, and the target flow in the sorted sequence is deleted, thereby detecting again whether the load rate is not more than the high level threshold. In other words, the processing flow sorted last in the sorting sequence can be selected (i.e. the processing flow with the smaller priority is selected earlier to perform the analysis frequency reduction processing). Next, when detecting that the load rate is still more than the high level threshold, the previous step again (i.e. the above-mentioned step about reducing the image analysis frequency) is performed. Next, when detecting that the load rate is not more than the high level threshold, the virtual hardware unit is used to execute the multiple operators according to respective resource allocation ratio of the multiple operators.

In some embodiment, the operator related to image processing is selected from the target flow, and the image analysis frequency of the operator related to image processing is reduced. For example, the deep learning operator and the computer vision operator are related to the image processing, and the image analysis frequencies (e.g. analyze-frame-rate) of the deep learning operator and the computer vision operator are reduced.

Notably, after the each analysis frequency reduction processing is performed, the virtual hardware unit is detected again whether the load rate is more than the high level threshold. Preparation for the detection reduction processing will not begin until all of the processing flows have performed the analysis frequency reduction processing and the virtual hardware unit is detected that the load rate is still more than the high level threshold.

In some embodiment, when having performed the analysis frequency reduction processing on the multiple processing flows and detecting that the load rate is still more than the high level threshold, the multiple processing flows is sorted again according to the comparing result to generate the sorted sequence. Next, the processing flow with the smallest priority in the sorting sequence as the target flow is selected, an object detection quantity corresponding to the target flow is reduced (i.e. the processing flow with the smaller priority is selected earlier to perform the detection reduction processing), and the target flow in the sorted sequence is deleted, thereby detecting again whether the load rate is not more than the high level threshold. Next, when detecting that the load rate is still more than the high level threshold, the previous step is performed again (i.e. the above-mentioned step about reducing the object detection quantity). Next, when detecting that the load rate is not more than the high level threshold, the virtual hardware unit is used to execute the multiple operators according to the respective resource allocation ratio of the multiple operators.

In some embodiment, the operator related to object detection is selected from the target flow, and the object detection quantity of the operator related to object detection is reduced. For example, the deep learning operator and the computer vision operator are related to the object detection, and the object detection quantities (e.g. a quantity of objects be detected) of the deep learning operator and the computer vision operator are reduced.

Notably, after the each detection reduction processing is performed, the virtual hardware unit is detected again whether the load rate is more than the high level threshold. Preparation for the flow pause processing will not begin until all of the processing flows have performed the detection reduction processing and the virtual hardware unit is detected that the load rate is still more than the high level threshold.

In some embodiment, when having performed the analysis frequency reduction processing and the detection reduction processing on the multiple processing flows and detecting that the load rate is still more than the high level threshold, the multiple processing flows is sorted again according to the comparing result to generate the sorted sequence. Next, the processing flow with the smallest priority in the sorting sequence is selected as the target flow, the target flow is paused (i.e. the processing flow with the smaller priority is selected earlier to perform the flow pause processing), and the target flow in the sorted sequence is deleted, thereby detecting again whether the load rate is not more than the high level threshold. Next, when detecting that the load rate is still more than the high level threshold, the previous step is performed again (i.e. the above-mentioned step about pausing the object detection quantity). Next, when detecting that the load rate is not more than the high level threshold, the virtual hardware unit is used to execute the multiple operators according to the respective resource allocation ratio of the multiple operators.

In some embodiment, all of the operators in the target flow are paused. For example, the target flow comprises the deep learning operator and the computer vision operator, and the deep learning operator and the computer vision operator are paused.

Notably, before selecting the target flow, that the priorities of the multiple processing flows above are all equal is found, and one of the multiple processing flows can be randomly selected as the target flow. In addition, ratios of the analysis frequency reduction processing and the detection reduction processing are preset by a user or obtained from past experiments.

Furthermore, in step S340, generating respective resource allocation ratio of the multiple operators in the multiple processing flows according to respective resource weights of the multiple operators, and using the virtual hardware unit to execute the multiple operators according to the multiple resource allocation ratios.

In some embodiment, a total weight can be calculated by adding all resource weights of the multiple operators, and a resource allocation ratio of the operator can be calculated by the resource weight of the operator divide by the total weight. For example, if one processing flow exists and the processing flow has two operators which each has a resource weight (30 and 40) for the virtual CPU, a resource allocation ratio of the first operator is 0.43, and a resource allocation ratio of the second operator is 0.57. In this way, the virtual hardware unit tends to allocate 43% operating resource to the first operator and tends to allocate 57% operating resource to the second operator.

Based on above-mentioned steps, the virtual hardware management device 100 can periodically determine whether the virtual hardware unit is in an overloud state. When in the overloud state, the processing flow to perform analysis the frequency reduction processing, the detection reduction processing, or the flow pause processing can be selected according to the priority of the processing flow. In this way, it can efficiently use the various algorithms and use the corresponding resources.

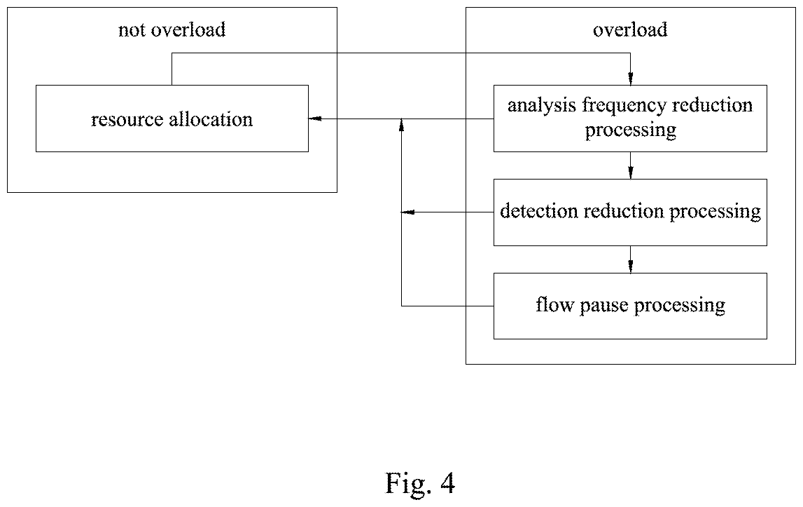

Reference is made to FIG. 4, which is a schematic diagram of processing performed by the virtual hardware unit on different states in some embodiments according to the present disclosure. As shown in FIG. 4, the virtual hardware unit can be in the state of overloud (i.e. overloud state) or not be in the state of overloud (i.e. normal state). The processing unit 120 can periodically determine whether the virtual hardware unit is in an overloud state. When the virtual hardware unit is in the overloud state, the processing flow to perform the analysis frequency reduction processing can be selected according to the priority of the processing flow (i.e. the processing flow with the smaller priority is selected earlier to perform the analysis frequency reduction processing). After the each analysis frequency reduction processing is performed, the virtual hardware unit is detected again whether the load rate is more than the high level threshold. Once the load rate is not more than the high level threshold, resource allocation can be performed.

When all of the processing flows have performed the analysis frequency reduction processing and the virtual hardware unit is still in the overloud state, the processing flow to perform the detection reduction processing can be selected according to the priority of the processing flow (i.e. the processing flow with the smaller priority is selected earlier to perform the detection reduction processing). After the each detection reduction processing is performed, the virtual hardware unit is detected again whether the load rate is more than the high level threshold. Once the load rate is not more than the high level threshold, resource allocation can be performed.

When all of the processing flows have performed the analysis frequency reduction processing and the detection reduction processing and the virtual hardware unit is still in the overloud state, the processing flow to perform the flow pause processing can be selected according to the priority of the processing flow (i.e. the processing flow with the smaller priority is selected earlier to perform the flow pause processing). After the each flow pause processing is performed, the virtual hardware unit is detected again whether the load rate is more than the high level threshold. Once the load rate is not more than the high level threshold, resource allocation can be performed.

In summary, the virtual hardware management device and method can periodically determine whether the virtual hardware unit is in the overloud state. When not in the overloud state, resource allocation can be performed according to the weights of the processing flows. Conversely, when in the overloud state, the processing flow to perform analysis the frequency reduction processing, the detection reduction processing, or the flow pause processing can be selected according to the priority of the processing flow. In this way, it can efficiently use the various algorithms and use the corresponding resources. In addition, it can prevent the occurrence of problems that used to require constant monitoring by the user.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A virtual hardware management device, comprising:
a memory, configured for storing a plurality of instructions and a plurality of processing flows; and
a processing unit, connected to the memory, and configured for executing the plurality of instructions to perform following operations:
detecting whether a load rate of a virtual hardware unit is more than a high level threshold, wherein the virtual hardware unit is created by virtualizing a physical hardware component;
when detecting that the load rate is more than the high level threshold, comparing respective priorities of the plurality of processing flows;
selecting at least one of the plurality of processing flows to perform at least one of analysis frequency reduction processing, detection reduction processing, or flow pause processing according to a comparing result until the load rate is not more than the high level threshold; and
generating respective resource allocation ratios of a plurality of operators in the plurality of processing flows according to respective resource weights of the plurality of operators, and using the virtual hardware unit to execute the plurality of operators according to the plurality of resource allocation ratios.

2. The virtual hardware management device of claim 1, wherein the processing unit is further configured for:
sorting the plurality of processing flows according to the comparing result to generate a sorted sequence, wherein the sorted sequence comprises the plurality of processing flows which are sorted;
selecting the processing flow with the priority which is smallest in the sorting sequence as a target flow, reducing an image analysis frequency corresponding to the target flow, and deleting the target flow in the sorted sequence, thereby detecting again whether the load rate is not more than the high level threshold;
when detecting that the load rate is still more than the high level threshold, performing previous step again; and
when detecting that the load rate is not more than the high level threshold, using the virtual hardware unit to execute the plurality of operators according to the plurality of resource allocation ratios.

3. The virtual hardware management device of claim 2, wherein the processing unit is further configured for:
selecting the operator related to image processing from the target flow, and reducing the image analysis frequency of the operator related to image processing.

4. The virtual hardware management device of claim 2, wherein the processing unit is further configured for:
when having performed the analysis frequency reduction processing on the plurality of processing flows and detecting that the load rate is still more than the high level threshold, sorting again the plurality of processing flows according to the comparing result to generate the sorted sequence;
selecting the processing flow with the priority which is smallest in the sorting sequence as the target flow, reducing an object detection quantity corresponding to the target flow, and deleting the target flow in the sorted sequence, thereby detecting again whether the load rate is not more than the high level threshold;
when detecting that the load rate is still more than the high level threshold, performing previous step again; and
when detecting that the load rate is not more than the high level threshold, using the virtual hardware unit to execute the plurality of operators according to the plurality of resource allocation ratios.

5. The virtual hardware management device of claim 4, wherein the processing unit is further configured for:
selecting the operator related to object detection from the target flow, and reducing the object detection quantity of the operator related to object detection.

6. The virtual hardware management device of claim 4, wherein the processing unit is further configured for:
when having performed the analysis frequency reduction processing and the detection reduction processing on the plurality of processing flows and detecting that the load rate is still more than the high level threshold, sorting again the plurality of processing flows according to the comparing result to generate the sorted sequence;
selecting the processing flow with the priority which is smallest in the sorting sequence as the target flow, pausing the target flow, and deleting the target flow in the sorted sequence, thereby detecting again whether the load rate is not more than the high level threshold;
when detecting that the load rate is still more than the high level threshold, performing previous step again; and
when detecting that the load rate is not more than the high level threshold, using the virtual hardware unit to execute the plurality of operators according to the plurality of resource allocation ratios.

7. The virtual hardware management device of claim 6, wherein the processing unit is further configured for:
pausing all of the operators in the target flow.

8. The virtual hardware management device of claim 1, wherein the operator performs machine learning operation, computer vision operation, image capture processing, or data processing.

9. A virtual hardware management method, comprising:
(a) sorting a plurality of processing flows according to respective priorities of the plurality of processing flows to generate a sorted sequence, wherein the sorting sequence comprises the plurality of processing flows which are sorted, wherein the plurality of processing flows comprises a plurality of operators;
(b) detecting whether a load rate of a virtual hardware unit is more than a high level threshold, wherein the virtual hardware unit is created by virtualizing a physical hardware component;
(c) when detecting that the load rate is more than the high level threshold, selecting the processing flow with the priority which is smallest in the sorting sequence as a target flow;
(d) performing analysis frequency reduction processing on the target flow, and deleting the target flow in the sorting sequence, thereby detecting again whether the load rate is not more than the high level threshold;
(e) when detecting that the load rate is still more than the high level threshold, perform steps (c) to (d) again; and
(f) when detecting that the load rate is not more than the high level threshold, generating respective resource allocation ratios of the plurality of operators according to respective resource weights of the plurality of operators in the plurality of processing flows, and using the virtual hardware unit to execute the plurality of operators according to the plurality of resource allocation ratios.

10. The virtual hardware management method of claim 9, wherein the step (d) comprises:
selecting the operator related to image processing from the target flow, and reducing an image analysis frequency of the operator related to image processing.

11. The virtual hardware management method of claim 9, further comprising:
when having performed the analysis frequency reduction processing on the plurality of processing flows and detecting that the load rate is still more than the high level threshold, sorting again the plurality of processing flows according to the respective priorities of the plurality of processing flows to generate the sorted sequence;
selecting the processing flow with the priority which is smallest in the sorting sequence as the target flow, performing detection reduction processing on the target flow, and deleting the target flow in the sorted sequence, thereby detecting again whether the load rate is not more than the high level threshold;
when detecting that the load rate is still more than the high level threshold, performing previous step again; and
when detecting that the load rate is not more than the high level threshold, using the virtual hardware unit to execute the plurality of operators according to the plurality of resource allocation ratios.

12. The virtual hardware management method of claim 9, wherein the step of performing the detection reduction processing on the target flow comprises:
selecting the operator related to object detection from the target flow, and reducing an object detection quantity of the operator related to object detection.

13. The virtual hardware management method of claim 9, further comprising:
when having performed the analysis frequency reduction processing and the detection reduction processing on the plurality of processing flows and detecting that the load rate is still more than the high level threshold, sorting again the plurality of processing flows according to the respective priorities of the plurality of processing flows to generate the sorted sequence;
selecting the processing flow with the priority which is smallest in the sorting sequence as the target flow, performing flow pause processing on the target flow, and deleting the target flow in the sorted sequence, thereby detecting again whether the load rate is not more than the high level threshold;
when detecting that the load rate is still more than the high level threshold, performing previous step again; and
when detecting that the load rate is not more than the high level threshold, using the virtual hardware unit to execute the plurality of operators according to the plurality of resource allocation ratios.

14. The virtual hardware management method of claim 13, wherein the step of performing the flow pause processing on the target flow comprises:
pausing all of the operators in the target flow.

15. A virtual hardware management method, comprising:
detecting whether a load rate of a virtual hardware unit is more than a high level threshold, wherein the virtual hardware unit is created by virtualizing a physical hardware component;
when detecting that the load rate is more than the high level threshold, randomly selecting one of a first processing flow and a second processing flow as a target flow, wherein a priority of the first processing flow is equal to a priority of the second processing flow, the first processing flow and the second processing flow each comprises a plurality of operators;
performing analysis frequency reduction processing on the target flow, thereby detecting again whether the load rate is not more than the high level threshold;
when detecting that the load rate is more than the high level threshold, selecting another one of a first processing flow and a second processing flow as the target flow, and performing the analysis frequency reduction processing on the target flow, thereby detecting again whether the load rate is not more than the high level threshold; and
when detecting that the load rate is not more than the high level threshold, generating respective resource allocation ratios of the plurality of operators according to respective resource weights of the plurality of operators in the first processing flow and the second processing flow, and using the virtual hardware unit to execute the plurality of operators according to the plurality of resource allocation ratios.

16. The virtual hardware management method of claim 15, wherein the step of performing the analysis frequency reduction processing on the target flow comprises:
selecting the operator related to image processing from the target flow, and reducing an image analysis frequency of the operator related to image processing.

17. The virtual hardware management method of claim 15, further comprising:
when having performed the analysis frequency reduction processing on the first processing flow and the second processing flow and detecting that the load rate is still more than the high level threshold, randomly selecting the one of the first processing flow and the second processing flow as the target flow, and performing detection reduction processing on the target flow, thereby detecting again whether the load rate is not more than the high level threshold;
when detecting that the load rate is still more than the high level threshold, performing previous step again; and
when detecting that the load rate is not more than the high level threshold, using the virtual hardware unit to execute the plurality of operators according to the plurality of resource allocation ratios.

18. The virtual hardware management method of claim 17, wherein the step of performing the detection reduction processing on the target flow comprises:
selecting the operator related to object detection from the target flow, and reducing an object detection quantity of the operator related to object detection.

19. The virtual hardware management method of claim 17, further comprising:
when having performed the analysis frequency reduction processing and the detection reduction processing on the first processing flow and the second processing flow and detecting that the load rate is still more than the high level threshold, randomly selecting the one of the first processing flow and the second processing flow as the target flow, and performing flow pause processing on the target flow, thereby detecting again whether the load rate is not more than the high level threshold;
when detecting that the load rate is still more than the high level threshold, performing previous step again; and
when detecting that the load rate is not more than the high level threshold, using the virtual hardware unit to execute the plurality of operators according to the plurality of resource allocation ratios.

20. The virtual hardware management method of claim 19, wherein the step of performing the flow pause processing on the target flow comprises:
pausing all of the operators in the target flow.
